(19) United States
(12) Patent Application Publication
(10) Pub. No.: US 2009/0022204 A1
(43) Pub. Date: Jan. 22, 2009

(54) METHOD FOR TEMPERATURE MEASUREMENT IN A MICROFLUID CHANNEL OF A MICROFLUID DEVICE

(76) Inventors: Dirk G. Kurth, Potsdam (DE); Alexander Iles, King Ston Upon Hull (GB)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/816,667

(22) PCT Filed: Feb. 8, 2006
(86) PCT No.: PCT/EP06/01112

§ 371 Date: Mar. 31, 2008

(30) Foreign Application Priority Data
Feb. 21, 2005 (DE) 10 2005 007 872.9

(51) Int. Cl. G01K 11/00; G06F 15/00

(52) U.S. Cl. 374/161; 702/134; 374/E11.001

(57) ABSTRACT

The invention relates to a method for temperature measurement in a microfluid channel of a microfluid device. According to the invention, a method for temperature measurement in a microfluid channel of a microfluid device, by means of which the temperature maybe simply measured with reliable accuracy, maybe achieved, whereby a volume element of the microfluid channel in which the temperature is to be measured is irradiated with a light source, elastically-scattered and other undesired light is separated off from the light with Raman scattering in the volume chamber, the Raman scattered light is recorded by a recording means, the recorded Raman scattered light is converted into Raman signals and the temperature in the volume element determined from the Raman signals.

The invention relates to a method for temperature measurement in a microfluidic channel of a microfluidic device.

In some areas of the natural sciences and medical diagnosis, microfluidic devices, for example microfluidic chips, have become indispensable tools or promising prospects on which hopes are pinned. In this case, the trend toward miniaturization with the aim of realizing reactions and analyses on a chip (on-chip) is driven forward primarily also by economic aspects since carrying out reactions and analyses in microfluidic channels promises many advantages.

These include firstly the fact that reactions and analyses can be carried out rapidly and in a manner that conserves resources on-chip by means of parallelization and automated control of reaction sequences, and likewise on account of high throughput rates and short transport times. Secondly, a controllable and efficient reaction implementation is possible, in principle, in particular by means of targeted and fast supply of heat and dissipation of heat. A further advantage is that microfluidic chips can be produced inexpensively in high numbers by means of photolithographic processes, for example, for which reason they are in particular also suitable for disposable use in medical diagnosis.

Recent developments in microfluidics technology are concerned with the concept of the “lab-on-a-chip” system, a microfluidic system that reduces method steps developed for implementation in a conventional laboratory to chip size.

In this case, particular importance is accorded to the polymerase chain reaction (PCR). It comprises the replication of gene fragments with the aid of repeated splitting and supplementation of the DNA double strand through biochemical reactions and has become an indispensable tool of molecular biology since it can increase extremely small sample quantities until the number of DNA molecules sought suffices to furnish unambiguous proof. Methods such as genetic fingerprinting would be inconceivable without the PCR, and the PCR also plays an important part in medical diagnosis, for instance for finding tumor genes in tissue samples or for identifying genetically governed diseases.

On account of the huge importance of the PCR, implementing it on-chip is highly advantageous since, besides the small reaction volume, only little chip material has to be heated and cooled during reactions on-chip, such that a miniaturized PCR system can run through the temperature cycles significantly faster than is possible with conventional methods. It thus becomes possible to perform almost 100 reaction steps with a PCR chip in a short time given accurate temperature regulation and to increase the quantity of DNA approximately ten-billion-fold.

However, precise temperature regulation of the reaction solution is crucial for a successful progression of the PCR. Each cycle of the chain reaction requires three temperature stages to be run through: in the denaturation phase (approximately 95° C.), the double-stranded DNA separates into two single strands. In the subsequent annealing step (approximately 50° C.), so-called primer DNA sequences attach to the single strands. In the final elongation phase (approximately 70° C.), special enzymes complete the single strands to form a new DNA double strand. The number of DNA molecules is thus doubled with each of these cycles.

Developing and extending the on-chip technology to areas of molecular synthesis whose success and yield are greatly dependent on precisely adhering to predetermined temperatures proves to be problematic, however, since, in the small volumes of microfluidic systems, the temperature can be measured only in a relatively complicated manner and not always with sufficient accuracy.

Methods known in the prior art for temperature measurement in microfluidic devices essentially comprise measurement by means of thermoelements or thermotransistors and also by means of fluorescence.

Temperature measurement by means of thermoelements and thermotransistors requires these to be integrated into the microfluidic device, it likewise being necessary to provide interfaces for tapping off the measured signals, which makes the construction and hence production of the microfluidic device more complicated. Furthermore, the wires connected to the thermoelements and thermotransistors are generally good thermal conductors which can dissipate heat from the region to be measured, which can lead to inaccuracies in the temperature measurement. Furthermore, the thermoelements and thermotransistors, in order to avoid reactions with the fluid medium or with the substances contained in the latter, have to be provided with an insulating layer, which makes it significantly more difficult to determine the in-situ temperature.

Since the temperature has a significant influence on fluorescence signals, it is possible to use the fluorescence for temperature measurement generally in microfluidic systems as well. However, what has proved to be disadvantageous in the case of this method is that besides the temperature, a multiplicity of further factors influence the fluorescence signals and, with the use of only one fluorescent dye, the system can be calibrated only with difficulty.

US 2003/0048831 A1 describes an optical method and an optical device based on a laser source for carrying out an optical method for the disturbance-free measurement of the temperature of a liquid flowing through a measuring chamber by means of fluorescence measurement, which is measured by means of a laser beam directed into the measuring chamber. The method consists in using a fluorescent tracer that is sensitive to a single temperature. The fluorescent tracer has at least two separate spectral detection windows. Rhodamine B, for example, is used as such a tracer.

GB 2373860 A discloses a monitoring system for measuring temperatures within a process chamber. Said chamber comprises a channel for the liquid to flow through, in which a chemical reaction takes place. The channel extends through the entire chamber. The chamber additionally comprises temperature sensors in order to measure the temperature of the liquid flowing through. The measurement principle consists in the fact that the liquid in the channel has a mass which can follow a temperature change, i.e. be heated or cooled, only after a certain time. As a result, the change in the temperature of the product can be measured from the relationship between the temperature coefficients of the fluid or the starting materials and the product during the chemical reaction.

DE 60002044 T2 describes a sensor and also a sensor housing for measuring the thermal conductivity of fluids. In particular, this involves an encapsulated sensor based on differential and absolute flow measurement of the fluid flowing through or of the convection flows thereof.

Therefore, the invention is based on the object of providing a method for temperature measurement in a microfluidic channel of a microfluidic device by means of which the temperature can be measured simply and with reliable accuracy.

This object is achieved according to the invention by virtue of the fact that

a volume element of the microfluidic channel in which the temperature is intended to be measured is irradiated by means of a light source;

elastically scattered and other undesirable light is separated from the light Raman-scattered in the volume element;

the Raman scattered light is detected by a detection means;

the detected Raman scattered light is converted into Raman signals;

the temperature prevailing in the volume element is calculated on the basis of the Raman signals.

By means of the solution according to the invention, it is possible to measure the temperature in a microfluidic channel of a microfluidic device simply and with reliable accuracy, the principle of the measurement method being based on so-called Raman scattering.

Raman scattering is the result of an inelastic interaction between a photon and a molecule. In this case, the frequency of the scattered photon changes since the energy of said photon changes, Stokes and anti-Stokes lines being obtained in the spectrum.

If, during the interaction, the photon emits part of its kinetic energy to the molecule as vibrational energy, then a red shift of the primary light beam occurs. This process is manifested in the Stokes lines of a spectrum. If the molecule is in an excited state, then it can also give the photon energy during the interaction with the latter and revert to the ground state in the process. The proton thus has a higher energy after the interaction than before the interaction, whereby its frequency changes and a blue shift of the primary light beam is observed.

At low temperatures the Stokes component is predominant in the spectrum since fewer molecules are in the excited state. If the temperature is increased, however, then more and more molecules attain the excited state, such that the proportion of anti-Stokes lines in the spectrum increases. The form and intensity of the spectrum thus change, information about the temperature being obtained by way of the form and the intensity.

The solution according to the invention furthermore has the advantage that the Raman effect is not restricted to a specific wavelength of the primary light beam, such that a multiplicity of different light sources are suitable for the measurement. Furthermore, the method is not invasive, for which reason in principle any transparent microfluidic device is suitable for being measured without appreciable influencing of the medium to be examined. Furthermore, the method according to the invention can be applied to microfluidic devices over a wide temperature range, in which case, beside the temperature, further information, for example the identity of molecules that arise or the arising of radicals and intermediate products, can be obtained by means of the Raman scattering obtained.

In the method according to the invention it is not absolutely necessary for the light Raman-scattered in the volume element to be separated from elastically scattered and other undesirable light, for example by means of a beam splitter, prior to its detection by means of the detection means. The separation can also be effected after detection and conversion of the Raman scattered light into Raman signals, e.g. by extraction of the Raman signals from the rest of the light signals.

Monochromatic light sources or arrangements which generate monochromatic light for example by means of monochromators or filters are suitable as light source. In order to increase the intensity of the Raman scattering and thus of the Raman signals, in accordance with one preferred embodiment of the invention it may be provided that the volume element of the microfluidic channel in which the temperature is intended to be measured is irradiated with laser light. By increasing the intensity of the Raman scattering, the accuracy of the temperature measurement can be improved further. The volume element can also be irradiated simultaneously with monochromatic light of different wavelengths.

If fluorescence signals are superposed on the Raman scattering, then in accordance with a further embodiment it may be provided that the volume element is irradiated with pulsed laser light in order to separate Raman scattering from fluorescence signals.

In order to increase the intensity of the Raman scattering and thus in order to improve the temperature measurement further it may be provided that the laser beam, by means of an arrangement of mirrors and lenses, is multiply conducted through the volume element in which the temperature is intended to be measured, and focused.

Furthermore, in order to increase the intensity of the Raman scattering, the microfluidic device may have mirror-coated surfaces which multiply conduct the radiated-in light through the volume element and/or focus the scattered light, in particular Raman scattered light. This can be achieved, in accordance with a particularly preferred embodiment, by virtue of the fact that regions of the surfaces delimiting the microfluidic channel are mirror-coated.

In order to collect a highest possible proportion of the Raman scattered light for the temperature measurement, it may be provided that the scattered light is focused by means of a lens. In this case, according to one development of the invention, the lens is an integral part of the microfluidic device.

In order to create a two- or three-dimensional temperature profile of the microfluidic channel, in accordance with a further preferred embodiment of the invention the temperature measurement is carried out in corresponding volume elements of the microfluidic channel. For this purpose, it may be provided, for example, that the detection means is focused onto the respective depth of the volume element, i.e. in the z direction, while either the detection means or the microfluidic device is correspondingly moved for correct positioning of the detection means in the x, y direction. It may also be provided that the Raman scattered light is detected by a set of detection means, such that it is not necessary to move an individual detection means or the microfluidic device.

In order to set a two- or three-dimensional temperature profile of the microfluidic channel, it may also be provided that the corresponding volume elements are successively irradiated selectively with light and the temperature is measured in each case separately for them.

In accordance with another preferred development of the invention, the Raman scattered light is fed to the detection means by means of a transfer means, preferably an optical fiber. Said transfer means may be arranged at the microfluidic device.

The detection of the Raman scattered light can be carried out by means of a photomultiplier, a photodiode, a CCD and/or a CMOS photodetector.

Particularly in the case of aqueous systems to be examined, the calculation of the temperature is preferably carried out on the basis of the shape of a Stokes line of an OH stretching vibration since water exhibits a temperature-dependent OH stretching vibration that is particularly well suited to these purposes.

As an alternative or in addition, the calculation of the temperature is carried out on the basis of the intensity of an anti-Stokes line of the Raman signals. In this case, for the temperature calculation, a calibration can be effected in a particularly simple manner by forming the ratio of the intensity of the anti-Stokes line and a corresponding Stokes line, the intensity of which is less temperature-dependent.

The accuracy of the temperature calculation can be improved further if it is effected by means of more than one pair of anti-Stokes line and corresponding Stokes line of a Raman-scattering molecule.

As an alternative, the temperature is calculated by a procedure in which, during the temperature calculation, the measured Raman signals are compared with Raman signals calculated theoretically for different temperatures, the temperature of the theoretically calculated signals which best resemble the measured Raman signals being assigned to the volume element.

In order to increase the sensitivity of the method further, in accordance with a further preferred embodiment it may be provided that the Raman scattered light is surface-amplified by means of metal colloids, for example. Metal colloids can be used for intensifying the scattered light during the surface-intensified Raman scattering (SERS, surface enhanced Raman spectroscopy). Silver nanoparticles are preferably used in this case, said nanoparticles being added for example to the fluid flowing through a microfluidic channel.

The invention furthermore relates to a use of the method according to the invention in the synthesis of molecules in a microfluidic device, in particular of biomolecules. In this case, preferred molecules are in particular oligonucleotides and polynucleotides, which are preferably synthesized by means of the polymerase chain reaction, and also oligopeptides, polypeptides and proteins.

The invention furthermore relates to a use of the method according to the invention in the production of biochips, in particular in the in-situ synthesis of biomolecules, during which the target molecules, i.e. the molecules having a known identity, are synthetized directly on the surface of the biochip. The invention further relates to a use of the method according to the invention in the production of laboratory-on-a-chip systems suitable for diagnosis methods.

Moreover, the invention relates to a use of the method according to the invention in the immobilization of molecules, in particular of peptides, proteins, oligonucleotides or polynucleotides, or cells on a matrix in a microfluidic device. During the immobilization, generally a precise setting of the temperature is necessary since, on the one hand, temperature-unstable protective groups have to be split off for initiating the immobilization reaction and, on the other hand, proteins, for example, must not be heated to an excessively great extent since otherwise there is the risk of their denaturation.

Furthermore, the invention relates to a use of the method according to the invention in the use of eukaryotic cells. Eukaryotic cells react particularly sensitively to temperature fluctuations, which necessitates a temperature measurement that is accurate to the greatest possible extent and a corresponding temperature regulation.

The invention furthermore relates to the use of the method according to the invention in the screening of catalysts. In the conversion of substrates by means of catalysts, heat of reaction is liberated. In this case, the magnitude of the evolution of heat is, inter alia, a measure of the activity of a catalyst. By means of the temperature measuring method according to the invention, therefore, in microfluidic devices potential catalysts for a predetermined reaction can be examined with regard to their activity and thus with regard to their suitability. Both homogeneous and heterogeneous catalysts or catalyst systems can be examined. In both of the latter, for example, a catalyst is immobilized in a region of a microfluidic channel of a microfluidic device and the evolution of heat during the reaction in said region is determined on the basis of the temperature, by means of which the activity of the catalyst can be determined.

The invention furthermore relates to a use of the method according to the invention in the synthesis of nanoparticles. In particular the size distribution and the crystallinity of nanoparticles crucially depend on the temperature during their synthesis, such that a corresponding temperature has to be adhered to with the greatest possible accuracy during the synthesis in order to obtain a desired size distribution and crystallinity of the particles. The temperature measuring method according to the invention is therefore preferably used in the synthesis of nanoparticles in microfluidic devices.

Furthermore, the invention relates to a use of the method according to the invention in label-free active ingredient screening. In general, active ingredient screenings in microfluidic devices are carried out by means of labeled substances, for example by means of fluorescence-labeled substances. Since the method according to the invention permits an accurate and sensitive temperature measurement within a microfluidic device, the temperature measuring method according to the invention can be used in label-free active ingredient screening, for example the affinity of a substance for a target molecule being determined by means of the thermal energy liberated by the binding to the target molecule, which can be measured on the basis of a temperature increase.

The invention furthermore relates to a use of the method according to the invention in label-free analytical electrophoresis in a microfluidic device, in which, with regard to the accuracy and the reproducibility of the electrophoresis, it is necessary to adhere precisely to a predetermined temperature.

Furthermore, the invention relates to a device for temperature measurement in a microfluidic channel of a microfluidic device, comprising

a light source for irradiating a volume element of the microfluidic channel in which the temperature is intended to be measured;

separating means for separating light Raman-scattered in the volume element from elastically scattered and other undesirable light;

detection means for detecting the separated Raman scattered light;

means for converting the detected Raman scattered light into Raman signals;

a computer for calculating the temperature prevailing in the volume element on the basis of the Raman signals;

a holding device, which can be equipped with a microfluidic device.

In accordance with one preferred embodiment of the device according to the invention, the light source is a laser light source. It is thereby possible to achieve an increase in the intensity of the Raman scattering and thus of the Raman signals.

It is favorable if the detection means for detecting the Raman scattered light is formed by a photodiode. Photodiodes are commercially available at particularly low cost and they can be used to detect the Raman scattered light sufficiently accurately and reliably.

With the device according to the invention it is possible to measure the temperature in a microfluidic channel of a microfluidic device. In order, in the event of deviation of the temperature measured in the microfluidic channel of the microfluidic device from the desired temperature, to be able to regulate the temperature in the channel, the holding device comprises at least one thermal element.

In order that the light source and a microfluidic device held by means of the holding device can be coordinated with one another such that the light source irradiates a predetermined volume element, it is provided that the holding device comprises an aligning device.

Preferably, the holding device can be equipped with a compact disk. Compact disks of this type are described in the document “Nature Biotechnology 2001 Aug; 19(8): 717-21”.

The device according to the invention preferably comprises a microfluidic device.

The description below, in connection with the drawing, serves for elucidating the invention. In the figures:

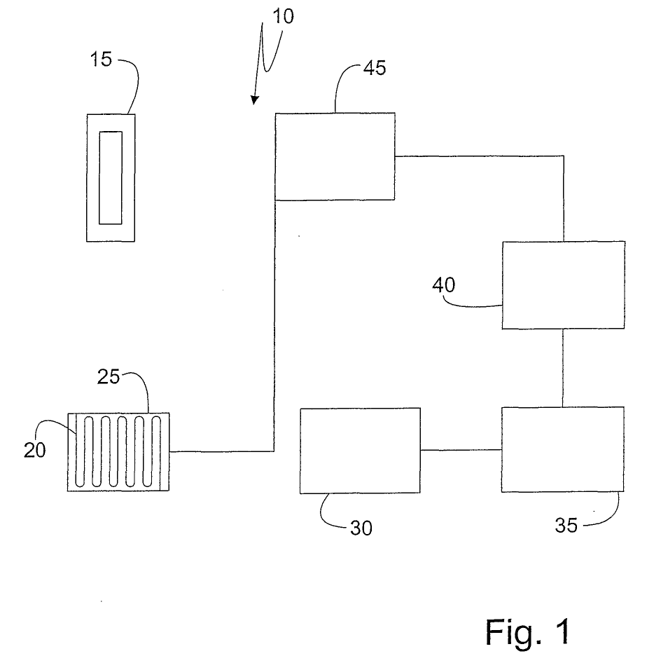

FIG. 1 shows a schematic view of a device according to the invention;

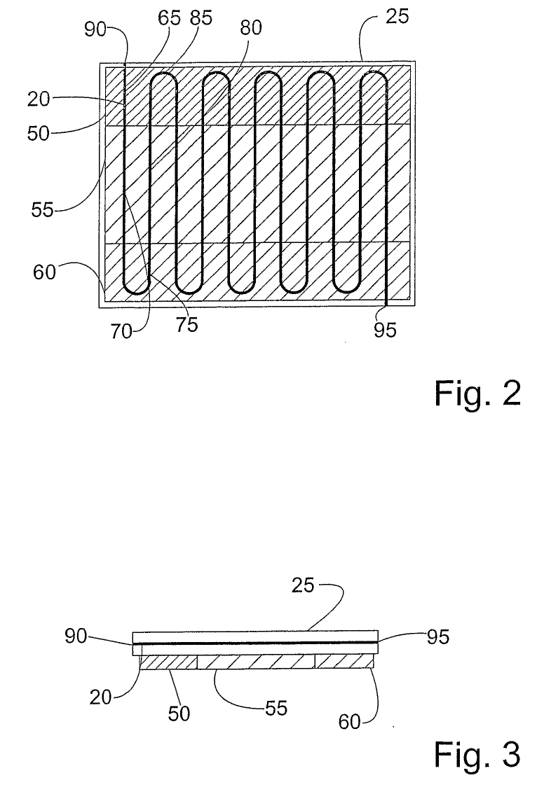

FIG. 2 shows a plan view of a microfluidic device held by a holding device of the device according to the invention;

FIG. 3 shows a view of one end of the holding device and of the microfluidic device.

FIG. 1 shows a device according to the invention, which is allocated the reference symbol 10 overall. The device comprises a laser 15 as light source, which can be used to irradiate in a targeted manner desired volume elements of a microfluidic channel 20 of a microfluidic chip 25 as microfluidic device in which the temperature is intended to be measured. The light scattered in the volume elements is collected and focused by means of a converging lens 30 and the scattered light is subsequently fed to a beam splitter 35 as separating means, which separates Raman-scattered light from elastically scattered and other undesirable light.

The separated Raman scattered light is conducted to a photodiode 40 as detection means for detecting the scattered light and as means for converting the detected Raman scattered light into Raman signals. The Raman signals are forwarded from the photodiode 40 to a computer 45, which calculates the temperature of the respective volume element from said signals. If the measured temperature values deviate from the desired values, then the actual temperatures are regulated to the desired values by means of thermal elements 50, 55, 60.

As can be seen from FIGS. 2 and 3, the microfluidic chip is on the three thermal elements 50, 55, 60 as holding device. The thermal elements 50, 55, 60 regulate the temperatures in the sections—located opposite them—of the microfluidic channel 20 of the microfluidic chip 25 for carrying out a polymerase chain reaction (PCR) to the desired temperatures of approximately 95° C., 50° C. and 70° C., respectively. In this case, each cycle of the PCR requires three temperature stages to be run through: in the denaturation phase (approximately 95° C.), the double-stranded DNA separates into two single strands. In the subsequent annealing step (approximately 50° C.), primer DNA sequences attach to the single strands. In the final elongation phase (approximately 70° C.), special enzymes complete the single strands to form a new DNA double strand. The number of DNA molecules is doubled with each of these cycles.

The PCR reaction solution entering the channel 20 via the inlet opening 90 firstly passes into the channel section 65, which is regulated to a temperature of 95° C. by means of the thermal element 50 and in which the double-stranded DNA separates into two single strands.

From the section 65, the solution then passes into the channel section 70, which is regulated to a temperature of 50° C. by means of the thermal element 55 and in which primer DNA sequences attach to the liberated single strands. After attachment of the primers, the reaction medium is led into the channel section 75, which is regulated to a temperature of 70° C. by means of the thermal element 60 and in which the single strands are completed to form a new DNA double strand and the cycle is concluded.

A renewed DNA doubling cycle begins with the denaturation phase if the solution enters the channel section 85, which is regulated to 95° C., via the section 80, which is temperature-regulated to 50° C. After the reaction solution has undergone a corresponding number of cycles, it emerges from the outlet opening 95 and is collected there.

1. A method for temperature measurement in a microfluidic channel (20) of a microfluidic device (25), in which
a volume element of the microfluidic channel (20) in which the temperature is intended to be measured is irradiated by means of a light source (15);
elastically scattered and other undesirable light is separated from the light Raman-scattered in the volume element;
the Raman scattered light is detected by a detection means (40);
the detected Raman scattered light is converted into Raman signals;
the temperature prevailing in the volume element is calculated on the basis of the Raman signals.

2. The method as claimed in claim 1, characterized in that the volume element of the microfluidic channel (20) in which the temperature is intended to be measured is irradiated with laser light.

3. The method as claimed in claim 2, characterized in that the laser light is pulsed laser light.

4. The method as claimed in claim 2, characterized in that the laser light, by means of an arrangement of mirrors and lenses, is multiply conducted through the volume element in which the temperature is intended to be measured, and/or focused.

5. The method as claimed in claim 1, characterized in that the microfluidic device (25) has mirror-coated surfaces which multiply conduct the radiated-in light through the volume element and/or focus the scattered light, in particular Raman scattered light.

6. The method as claimed in claim 5, characterized in that regions of the surfaces delimiting the microfluidic channel (20) are mirror-coated.

7. The method as claimed in claim 1, characterized in that the scattered light is focused by means of a lens (30).

8. The method as claimed in claim 7, characterized in that the lens is an integral part of the microfluidic device (25).

9. The method as claimed in claim 1, characterized in that the temperature measurement is carried out in a plurality of mutually different volume elements of the microfluidic channel (20) in order to create a two- or three-dimensional temperature profile of the channel (20).

10. The method as claimed in claim 1, characterized in that the Raman scattered light is fed to the detection means (40) by means of a transfer means, preferably an optical fiber.

11. The method as claimed in claim 10, characterized in that the transfer means is arranged at the microfluidic device (25).

12. The method as claimed in claim 1, characterized in that the detection of the Raman scattered light is carried out by means of a photomultiplier, a photodiode (40), a CCD or a CMOS photodetector.

13. The method as claimed in claim 1, characterized in that the calculation of the temperature is carried out on the basis of the shape of a Stokes line of the Raman signals.

14. The method as claimed in claim 1, characterized in that the calculation of the temperature is carried out on the basis of the intensity of an anti-Stokes line of the Raman signals.

15. The method as claimed in claim 14, characterized in that a calibration is effected during the temperature calculation, during which calibration the ratio of the intensity of the anti-Stokes line and a corresponding Stokes line is formed.

16. The method as claimed in claim 15, characterized in that the temperature calculation is effected by means of more than one pair of anti-Stokes line and corresponding Stokes line of a Raman-scattering molecule.

17. The method as claimed in claim 1, characterized in that, during the temperature calculation, the measured Raman signals are compared with Raman signals calculated theoretically for different temperatures, the temperature of the theoretically calculated signals which best resemble the measured Raman signals being assigned to the volume element.

18. The method as claimed in claim 1, characterized in that the Raman scattered light is surface-amplified by means of metal colloids, for example.

19. The use of a method as claimed in claim 1 in the synthesis of molecules, in particular of biomolecules, in a microfluidic device (25).

20. The use as claimed in claim 19, characterized in that the molecules are oligonucleotides.

21. The use as claimed in claim 19, characterized in that the molecules are polynucleotides.

22. The use as claimed in claim 19, characterized in that the reaction for the synthesis of the molecules is a polymerase chain reaction.

23. The use as claimed in claim 19, characterized in that the molecules are oligopeptides or polypeptides.

24. The use as claimed in claim 19, characterized in that the molecules are proteins.

25. The use of the method as claimed in claim I in the production of biochips or in the production of laboratory-on-a-chip systems suitable for diagnosis methods.

26. The use of the method as claimed in claim I in the immobilization of molecules, in particular of peptides, proteins, oligonucleotides or polynucleotides, or cells on a matrix in a microfluidic channel (20) of a microfluidic device (25).

27. The use of the method as claimed in claim 1 in the use of eukaryotic cells.

28. The use of the method as claimed in claim 1 in the screening of catalysts.

29. The use of the method as claimed in claim 1 in the synthesis of nanoparticles.

30. The use of the method as claimed in claim 1 in carrying out a label-free active ingredient screening.

31. The use of the method as claimed in one of claims 1 to 18 claim 1 in carrying out a label-free electrophoresis.

32. A device (10) for temperature measurement in a microfluidic channel (20) of a microfluidic device (25), comprising
a light source (15) for irradiating a volume element of the microfluidic channel (20) in which the temperature is intended to be measured;
separating means (35) for separating light Raman-scattered in the volume element from elastically scattered and other undesirable light;
detection means (40) for detecting the separated Raman scattered light;
means (40) for converting the detected Raman scattered light into Raman signals;
a computer (45) for calculating the temperature prevailing in the volume element on the basis of the detected Raman signals;
a holding device (50, 55, 60), which can be equipped with a microfluidic device (25).

33. The device as claimed in claim 32, characterized in that the light source (15) is a laser light source.

34. The device as claimed in claim 32, characterized in that the detection means (40) for detecting the Raman scattered light is formed by a photodiode.

35. The device as claimed in claim 32, characterized in that the holding device (50, 55, 60) comprises at least one thermal element.

36. The device as claimed in claim 32, characterized in that the holding device (50, 55, 60) comprises an aligning device.

37. The device as claimed in claim 32, characterized in that the holding device (50, 55, 60) can be equipped with a compact disk.
